(19) United States
(12) Patent Application Publication
(10) Pub. No.: US 2017/0332021 A1
(43) Pub. Date: Nov. 16, 2017

(54) INFRARED ILLUMINATION THROUGH BACKGROUND LIGHTING SOURCE

(71) Applicant: MICROSOFT TECHNOLOGY LICENSING, LLC, Redmond, WA (US)

(72) Inventors: Chengwu Cui, Redmond, WA (US); Ying Zheng, Redmond, WA (US)

(73) Assignee: MICROSOFT TECHNOLOGY LICENSING, LLC, Redmond, WA (US)

(21) Appl. No.: 15/153,745

(22) Filed: May 13, 2016

(51) Int. Cl. H04N 5/33; H04N 5/225; F21V 8/00

(52) U.S. Cl. CPC H04N 5/33; G02B 6/0068; H04N 5/2256

(57) ABSTRACT

Technologies are provided for IR illumination through background lighting sources. Some examples are directed to as IR light source such as IR LEDs being interspersed with visible light sources (e.g., LEDs) in a light guide of a display. IR LED configuration and/or light extraction features of the light guide may be selected such that a desired IR illumination pattern (e.g., a more centralized or a more uniform pattern) can be achieved. In other examples, an activation (turning on/off) of the IR LEDs may be used to generate the desired IR illumination pattern. The IR LEDs may be driven by the same circuitry as the visible light LEDs or by dedicated drive circuitry. Furthermore, the IR LEDs may be activated in an interlaced form with the visible light LEDs (e.g., selected frames in a stream of frames) to provide the IR illumination while displaying content.

### BACKGROUND

Infrared (IR) cameras need infrared illumination, which may typically be provided via additional light sources added to a device such as a tablet or a cellphone. Additional illumination sources may add to the overall cost of the device due to the additional components and needed space. Additional light sources may also increase a complexity of industrial, electronic, and software design. The components may need to be fitted within the ergonomic and stylistic design of the device, electrical and/or software coordination and control of the additional light sources may result in added tasks to existing components and programs of the device or new components and/or programs.

### SUMMARY

This summary is provided to introduce a selection of concepts in a simplified form that are further described below is the Detailed Description. This summary is not intended to exclusively identify key features or essential features of the claimed subject matter, nor is it intended as an aid in determining the scope of the claimed subject matter.

Embodiments are directed to providing infrared illumination through background lighting sources. In some examples, activation of an IR image capture device may be detected at a computing device that includes a display to provide the infrared illumination. A desired or suitable IR illumination pattern may be determined based on user input or an IR image capture type such as facial recognition, retinal recognition, or a scene capture. The IR LEDs interspersed with visible light LEDs of the display may then be activated according to the IR illumination pattern, where the activation of the IR LEDs may be controlled spatially or temporally, for example, through an arrangement of LED distribution, an arrangement of light extraction features of the display, or activation of the IR LEDs during a subset of displayed frames. The IR LEDs may be deactivated upon completion of the IR image capture.

These and other features and advantages will be apparent from a reading of the following detailed description and a review of the associated drawings, it is to be understood that both the foregoing general description and the following detailed description are explanatory and do not restrict aspects as claimed.

### BRIEF DESCRIPTION OF THE DRAWINGS

FIG. 1 is a display diagram illustrating an example computing device, where the display serves also as m illumination source for an integrated camera;

FIG. 2A is a display diagram illustrating a white Light Emitting Diode (LED) array and light guide plate design of a display panel;

FIG. 2B is a display diagram illustrating a cross section of LEDs and light guide plate of a display panel showing a lighting extraction feature to direct light to a desired area of the display;

FIG. 3 is a display diagram illustrating an example visible light LED array and light guide plate design of a display panel with IR LEDs next to visible light LEDs, according to embodiments;

FIG. 4A is a display diagram illustrating generation of an IR illumination pattern that is more concentrated in the center through IR LEDs interspersed between visible light LEDs in the light guide, according to embodiments;

FIG. 4B is a display diagram illustrating generation of another IR illumination pattern that is more uniformly distributed through IR LEDs interspersed between visible light LEDs in the light guide, according to embodiments;

FIG. 5 is a display diagram illustrating a display with a pixel pattern that includes a text message illuminated in IR light over a dark background, according to embodiments;

FIG. 6 is a display diagram illustrating visible frames interlaced with IR illuminated frames;

FIG. 7 is a block diagram of an example computing device, which may be used for providing infrared illumination through background lighting sources, according to embodiments; and

FIG. 8 is a logic flow diagram illustrating a process for providing infrared illumination through background lighting sources, according to embodiments.

### DETAILED DESCRIPTION

As briefly described above, embodiments are directed to IR illumination through background lighting sources. Some examples are directed to an IR light source such as IR LEDs being interspersed with visible light sources (e.g., LEDs) in a light guide of a display. IR LED configuration and/or light extraction features of the light guide may be selected such that a desired IR illumination pattern (e.g., a more centralized or a more uniform pattern) can be achieved. In other examples, an activation (turning on/off) of the IR LEDs may be used to generate the desired IR illumination pattern. The IR LEDs may be driven by the same circuitry the visible light LEDs or by dedicated drive circuitry. Furthermore, the IR LEDs may be activated in an interlaced form with the visible light LEDs (e.g., selected frames in a stream of frames) to provide the IR illumination while displaying content.

In the following detailed description, references are made to the accompanying drawings that form a part hereof, and in which are shown by way of illustrations, specific embodiments, or examples. These aspects may be combined, other aspects may be utilized, and structural changes maybe made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the an will recognize that aspects may also be implemented in combination with other program modules.

Generally, program modules sac hide routines programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example processes). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing infrared illumination through background lighting sources. Examples of platforms include, but are not limited to, a hosted service executed over a plurality of servers, an application executed on a single computing device, a device operating system, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that allow the application or service to interact or communicate with one or more other applications and services managed by separate entities.

The technical advantages of providing infrared illumination through background lighting sources may include, among others, increased efficiency and reliability of computing devices with IR cameras through reduced design and component complexity, enhanced IR-related functionality, and improved user experience by allowing IR camera operations to be simplified through the background lighting based illumination.

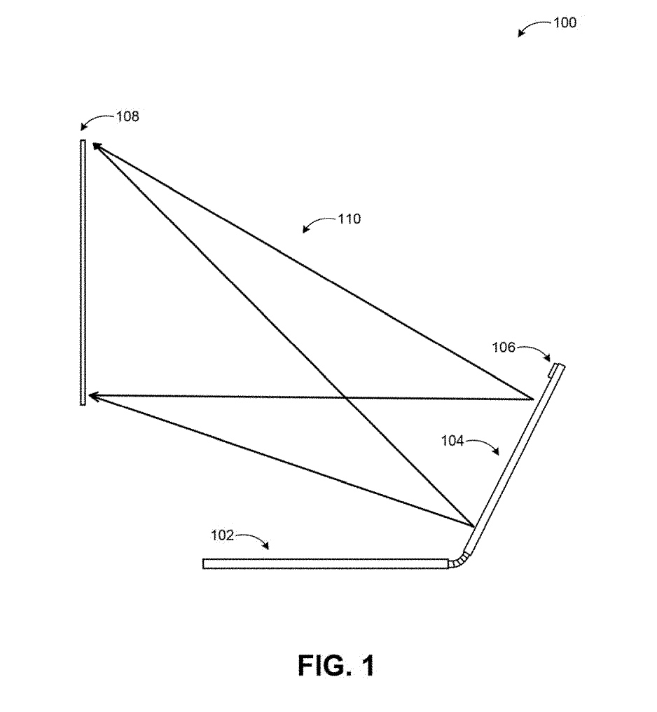

FIG. 1 is a display diagram illustrating an example computing device, where the display serves also as an illumination source for an integrated camera.

Use of infrared cameras in computing devices such as tablet computers, smart phones, etc. may provide useful features such as biometric authentication, gesture recognition, etc. In conventional devices, the IR illumination source: such as IR LEDs are often provided as illumination sources for the IR cameras. These LED light sources may be used together with light guides or other optics to provide more efficient and uniform illumination. Moreover, the IR LEDs usually have their own driving circuitry and wiring. For these reasons, inclusion of the IR LEDs may involve substantial additional space in the often-crowded devices. The need for additional space may be particularly challenging for mobile devices with slim form factors.

Diagram 100 shows a mobile device use configuration. The display 104, which is mechanically coupled to the body 102 of the device, is backlit with LEDs via light guides and other components. The lit display 104 also serves as an illumination source illuminating a target area 108 through background light 110. A camera 106 may utilize the illumination to capture the target area.

The display 104 may utilize elaborate light piping and distribution components to provide uniform and efficient illumination for the display panel. Using the same system, with additional LED die or dies incorporated, infrared illumination may be provided for an infrared camera in applications such as face recognition, iris recognition, gesture recognition, etc.

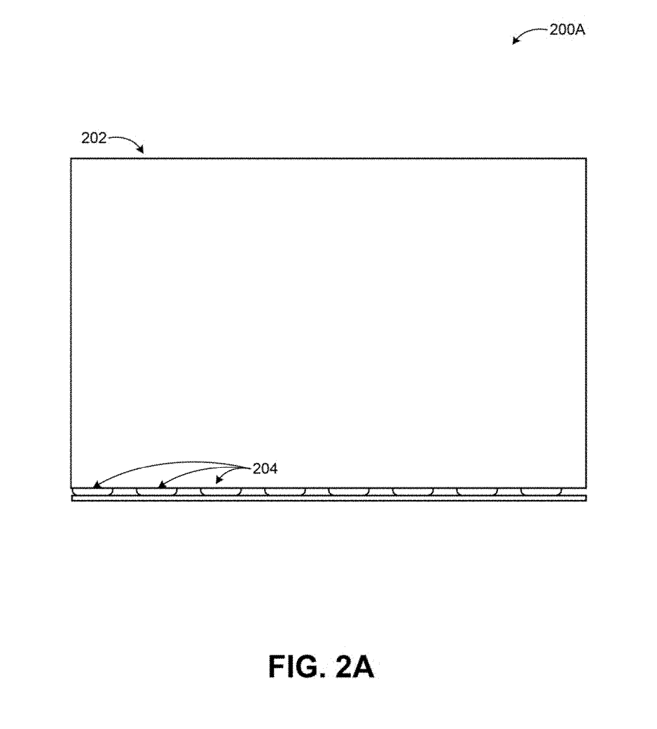

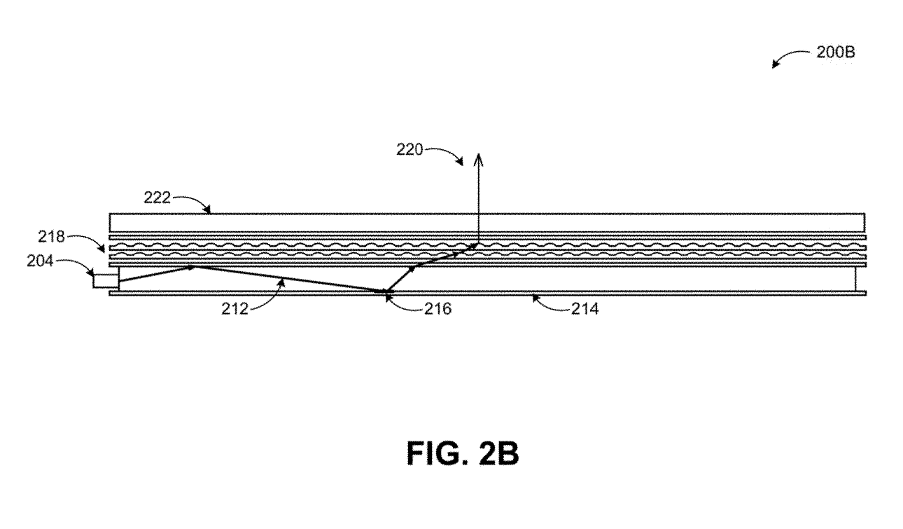

FIG. 2A is a display diagram illustrating a white Light Emitting Diode (LED) array and light guide plate design of a display panel.

Diagram 200A shows a visible light LED array 204 and a light guide plate 202 of a back lit display illumination system. The visible light LEDs 204 provide the illumination via the light guide plate 202 and other reflective or refractive parts shown in FIG. 2B. Visible light LEDs used for background lighting may typically be distributed in a uniform fashion because uniform backlighting is desired in displays.

FIG. 2B is a display diagram illustrating a cross section of LEDs and light guide plate of a display panel showing a lighting extraction feature to direct light to a desired area of the display.

As shown in diagram 200B, a light guide plate may include multiple layers such as reflective layer 214. Light 212 from light source 204 (e.g., an LED) may be piped through the transportation layer and reflected at selected locations through light extraction features 216. The reflected light beam may pass through one or more polarization filter layers 218 and be emitted perpendicular to the surface plane of the display at the top layer 222 as light beam 220. The light extracting features 216 and the polarization filter layers 218 may enable direction of light from the LED(s) in a controlled manner such that the display panel is uniformly illuminated. The light source 204 may include white LEDs, red-green-blue (RGB) LEDs, or similar light sources based on the display panel's color scheme.

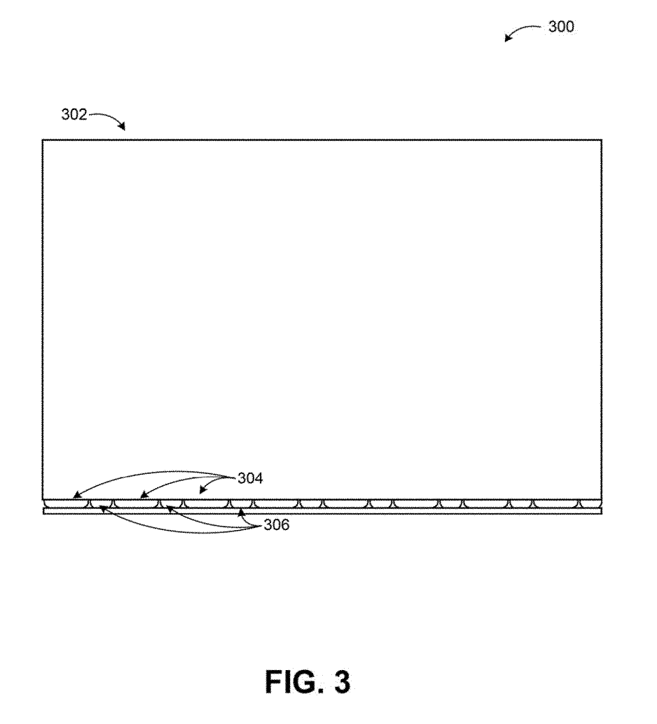

FIG. 3 is a display diagram illustrating an example visible light LED array and light guide plate design of a display panel with IR LEDs next to visible light LEDs, according to embodiments.

As shown in diagram 300, IR LEDs 306 may be arranged in an interspersed manner with the visible light LEDs 304 in the light guide plate 302. Depending on display type, device design parameters (e.g., power consumption, desired display brightness, etc.), and applicable IR illumination needs, an arrangement and/or a number of the IR LEDs may be selected. For example, in some embodiments, an equal number of IR LEDs and visible light LEDs may be laid out in substantially equal distribution. In other embodiments, fewer IR LEDs may be placed between groups of visible light LEDs for a particular IR illumination.

The IR LEDs 306 may be controlled by dedicated driver circuitry in some examples. Yet, in other examples, the IR LEDs 306 may be controlled by similar or same driver circuitry as the visible light LEDs 304. The visible light LEDs 304 may include white light LEDs or other color LEDs. For example, in a monochrome display, the visible light LEDs 304 may be of a particular color. Alternatively, the visible light LEDs 304 may include a number of base colors such as red, green, and blue in a RGB color scheme display. The IR LEDs 306 may be configured such that the IR light from the IR LEDs 306 is guided to exit the front of the display in the same manner as the light from the visible light LEDs 304.

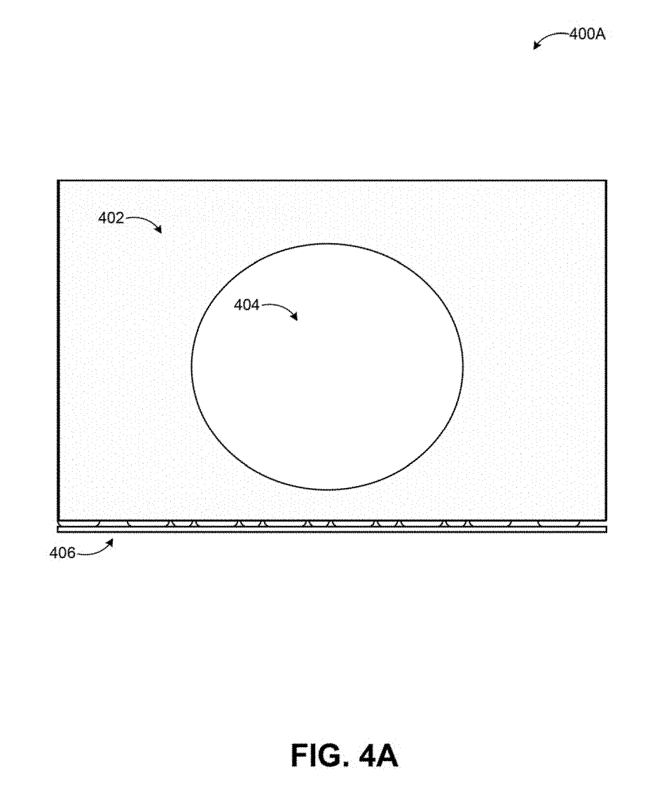

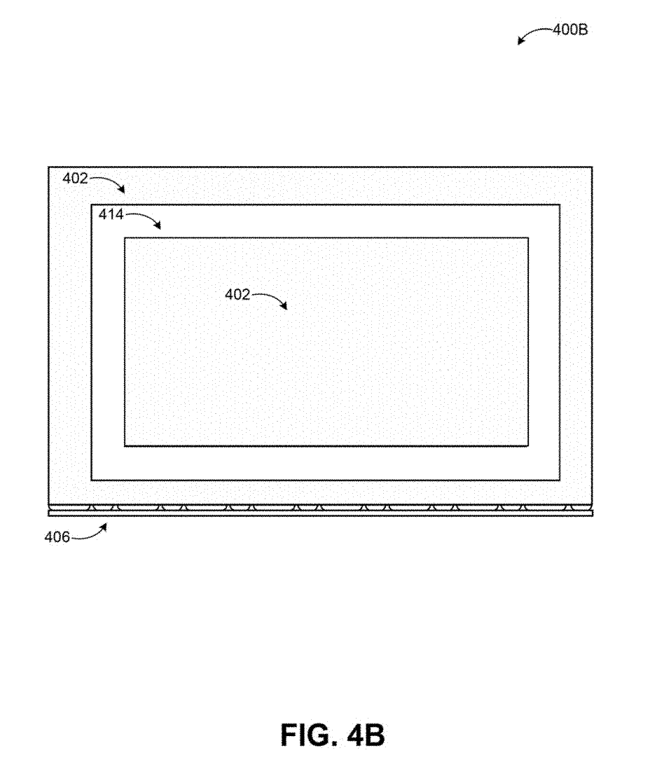

FIG. 4A is a display diagram illustrating generation of an IR illumination pattern that is more concentrated in die center through IR LEDs interspersed between visible light LEDs in the light guide, according to embodiments.

In the example IR light extraction pattern shown in diagram 400A, the circular area 404 includes light extraction features that allow IR light to be emitted from the display as opposed to light extraction features of typical visible (e.g., white) light features.

The light extraction features for the visible light and IR light may have different light extraction efficiency depending on the wavelength. In the example illumination pattern, the IR light extraction features may have high reflectivity in the near IR wavelength to redirect the IR light from IR LEDs 406 such that a circular IR illumination pattern is achieved. The visible light extraction features outside the circular center area (area 402) may have high reflectivity in visible wavelengths to redirect the visible light. The example illumination pattern may be used for retina identification or similar focused IR applications.

FIG. 4B is a display diagram illustrating generation of another IR illumination pattern that is more uniformly distributed through IR LEDs interspersed between white LEDs in the light guide, according to embodiments.

Diagram 400B shows another extraction feature pattern resulting in a uniform IR illumination, for example, for face identification applications. The light extraction features may be arranged such that the central, rectangular area and the rectangular band near the edges of the display (areas 402) have high efficiency for visible light; while the rectangular band area 414 includes high efficiency light extraction features for both the visible light and the IR light. This way the entire display may emit visible light in a substantially uniform manner while the IR light is also emitted uniformly.

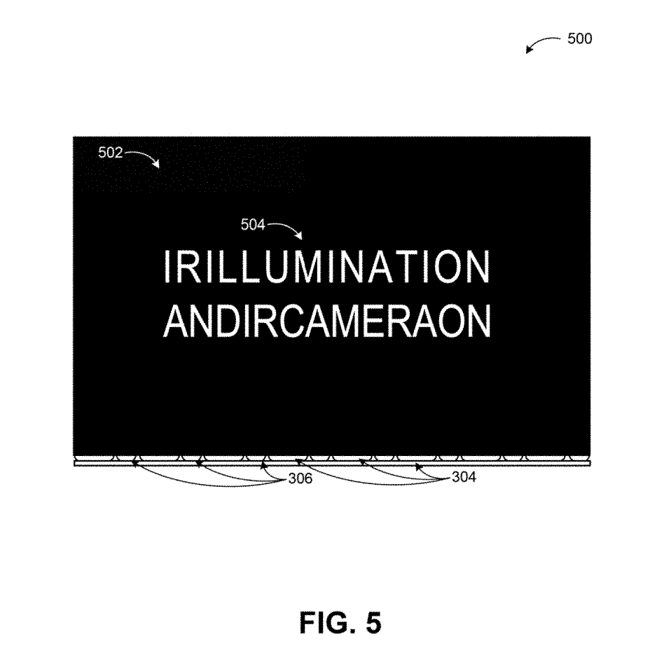

FIG. 5 is a display diagram illustrating a display with a pixel pattern that includes a text message illuminated in IR light over a dark background, according to embodiments.

When using an IR camera with IR illumination, an underlying display that provides the background illumination may operate in different modes. One mode may include the typical use of the display, and when the device is for special use such as biometric authentication, a login screen may be on so long as the display pixels are displacing an image that will allow substantial IR light through. Alternatively, the display image may take a predefined pattern that may provide an efficient illumination pattern. In yet another mode, the pattern may also catty additional information 504 to the user such as “IR ILLUMINATION AND IR CAMERA ON” overlaid over the original display content 502 as shown in diagram 500. The display content 502 (as well as the additional information 504) may be provided by the visible light LEDs 304, while the IR illumination (through the displayed pattern or text) may be provided by the IR LEDs 306.

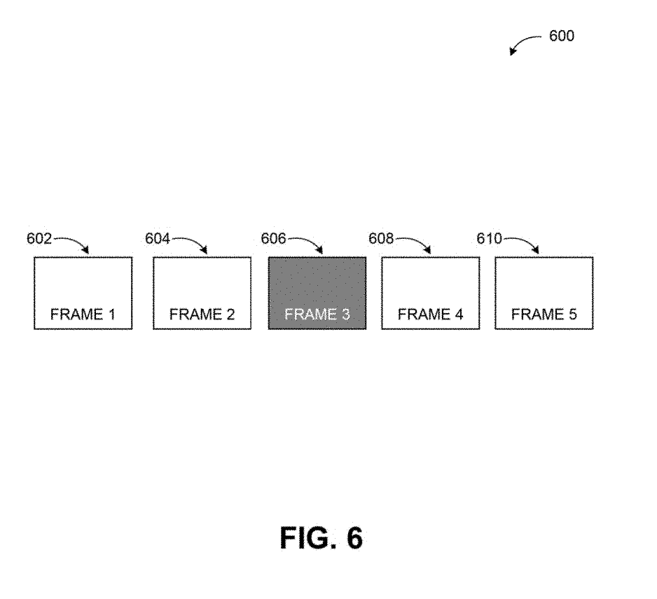

FIG. 6 is a display diagram illustrating visible frames interlaced with IR illuminated frames.

As discussed above, IR illumination to provide background lighting for an IR image capture device may be provided without visible content being displayed or simultaneously with the visible content on a display through spatial arrangement and activation of the deferent LEDs

In other embodiments, the IR illumination may be provided through temporal arrangement of activation of the IR LEDs. For example, as shown in diagram 600, visible content may be displayed as frames (602, 604, 608, and 610). IR illumination may be inserted as a frame 606 in between the visible content frames. In some examples, visible content may be turned off during frame 606 and a duration of the frame 606 may be selected such that it is unnoticeable to a user. In other examples, both visible contest and IR illumination may be provided during frame 606.

A textual scheme, a graphical scheme, an animation scheme, a coloring scheme, a highlighting scheme, and/or a shading scheme may be employed to provide IR illumination through display backlight systems in conjunction with the functionality described herein.

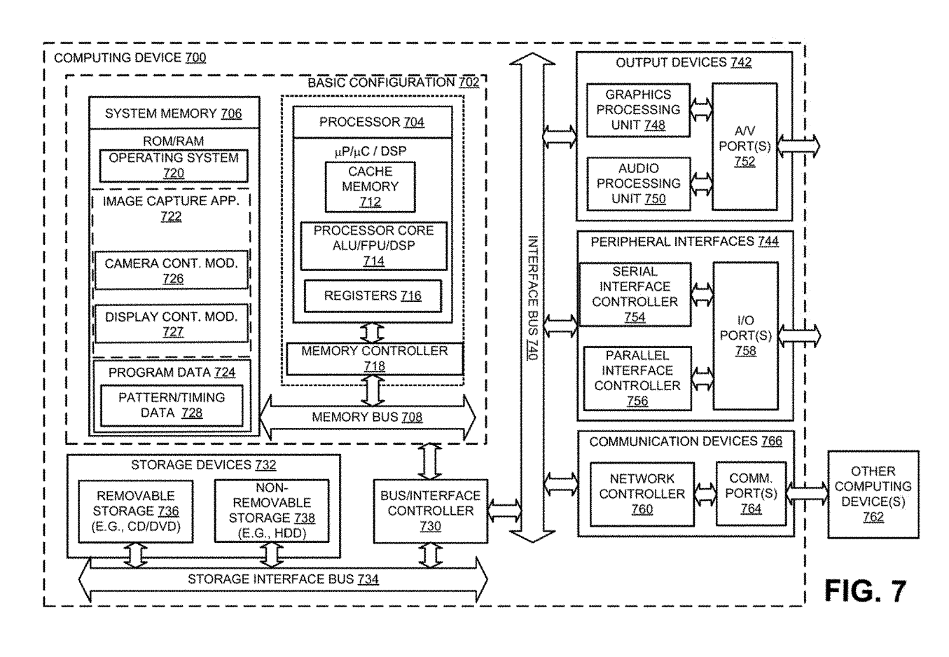

FIG. 7 is a block diagram of an example computing device, which may be used for providing infrared illumination through background lighting sources, according to embodiments.

For example, a computing device 700 may be used as a desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The example basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The one or more processor cores 714 may (each) include an arithmetic logic unit (ALU), a floating point unit (FPU), a digital signal processing core (DSP Core), or any combination thereof. An example memory controller 718 may also be used with the processor 704, or in some implementations, the example memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, an image capture application 722, and program data 724. The image capture application 722 may include a camera control module 726 and a display control module 727, which may perform various tasks in providing infrared illumination through background lighting sources. Program data 724 may include, among others, pattern/timing data 728 associated with selecting an IR illumination pattern.

The computing device 700 may have additional features or functionality, and additional interfaces to facilitate communications between the example basic configuration 702 and any desired devices and interfaces. For example, a bus/interface controller 730 may be used to facilitate communications between the example basic configuration 702 and one or more data storage devices 732 via a storage interface bus 734. The data storage devices 732 may be one or more removable storage devices 736, one or more non-removable storage devices 738, or a combination thereof Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSDs), and tape drives, to name a few. Example computer storage media may include volatile and non-volatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the example basic configuration 702 via the bus/interface controller 730. Some of the one or more output devices 742 include a graphics processing unit 748 and an audio processing unit 750, which may be configured to communicate to various external devices such as a display or speakers via one or more A/V ports 752. The one or more peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media.

Example embodiments may also include methods for providing infrared illumination through background lighting sources. These methods can be implemented in any number of ways, including the structures described herein. One such way maybe by machine operations, of devices of the type described in the present disclosure. Another optional way may be for one or more of lire individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

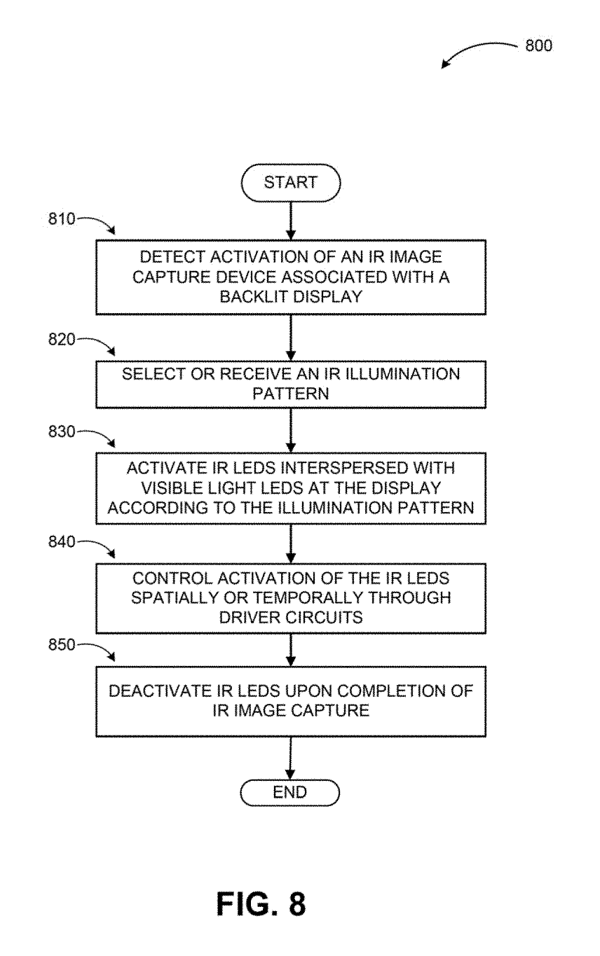

FIG. 8 is a logic flow diagram illustrating a process for providing infrared illumination through background lighting sources, according to embodiments. A process 800 may be implemented by an image capture application executed on a mobile or stationary computing device with IR image capture capability, an operating system of a similar device, or a module configured to control display functionality of a similar device.

The process 800 may begin with operation 810, where activation of an IR image capture device may be detected at a computing device that includes a display to provide the infrared illumination. At operation 820, a desired or suitable IR illumination pattern may be received from a user or selected automatically based on a type of the IR image capture device, an environmental lighting status (e.g., dark environment, brightly lit environment, etc.), or an IR image capture type such as facial recognition, retinal recognition, or a scene capture.

The IR LEDs interspersed with visible light LEDs of the display may be activated at operation 830 according to the IR illumination pattern. The activation of the IR LEDs may be controlled at operation 840 spatially or temporally, for example, through an arrangement of LED distribution, an arrangement of light extraction features of the display, or activation of the IR LEDs during a subset of displayed frames. The IR LEDs may be deactivated upon completion of the IR image capture at operation 850.

The operations included in process 800 are for illustration purposes. Providing infrared illumination through background lighting sources may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device to provide background infrared (IR) illumination for IR image capture is described. The computing device may include a display configured to present visible content and IR illumination, a memory configured to store instructions, and a processor configured to execute a display control module. The display control module may be configured to detect activation of an IR image capture device associated with the computing device and activate a plurality of IR light emitting diodes (LEDs) interspersed in between a plurality of visible light LEDs according to an IR illumination pattern, where the IR illumination pattern may be defined through spatially based on one of an arrangement of the IR LEDs and an arrangement of light extraction features of the display or temporally through activation of the IR LEDs during an IR illumination frame, the IR illumination frame being preceded and succeeded by a plurality of visible illumination frames. The display control module may also be configured to deactivate the IR LEDs upon completion of the IR image capture.

According: to other examples, a shape and a location of the IR illumination pattern on the display may be selected based on one more of a type of the IR image capture device, a type of the IR image capture, and an environmental lighting status. The IR illumination pattern may be defined by spatial arrangement of a first subset of light extraction features that have high efficiency near IR wavelengths and a second subset of light extraction features that have high efficiency near visible light wavelengths. The display control module may be further configured to display a combination of visible content and IR illumination during the IR illumination frame.

According to further examples, the IR LEDs may be activated through driver circuits distinct from driver circuits for the visible light LEDs. A number of the IR LEDs may be smaller than a number of the visible light LEDs. A number of the IR LEDs may also be about equal to a number of the visible light LEDs. The IR illumination pattern may be provided through a displayed text or shape over a uniform visible background pattern on the display. The display control module may be a standalone module, part of an image capture application, or part of an operating system. The IR image capture device may be integrated with the computing device. The visible light LEDs may include white light LEDs, monochrome LEDs, or colored LEDs according to a color scheme of the display.

According to other examples, a method executed at a computing device to provide background infrared (IR) illumination for IR image capture is described. The method may include detecting activation of an IR image capture device associated with the computing device; determining an IR illumination pattern; activating a plurality of IR light emitting diodes (LEDs) interspersed with visible light LEDs of a display of the computing device according to the IR illumination pattern, where the activation of the IR LEDs is controlled spatially or temporally; and deactivating the IR LEDs upon completion of the IR image capture.

According to some examples, determining the IR illumination pattern may include receiving an IR illumination pattern definition or selecting the IR illumination pattern from a plurality of IR illumination patterns. The method may further include selecting the IR illumination pattern from the plurality of IR illumination patterns based on one more of a type of the IR image capture device, a type of the IR image capture, and an environmental lighting status. The type of the IR image capture may include a facial recognition, a retinal recognition, and/or a scene capture. Activating the plurality of IR LEDs may include turning the IR LEDs on during an IR illumination frame, where the IR illumination frame may be preceded and succeeded by a plurality of visible illumination frames.

According to further examples, a display device to provide background infrared (IR) illumination for IR image capture is described. The display device may include a display panel; a light guide panel electrically and optically coupled to the display panel, where the light guide panel may include a light extraction layer, a plurality of visible light emitting diodes (LEDs), and a plurality of IR LEDs interspersed in between the visible light LEDs; and a processor. The processor may be configured to detect activation of an IR image capture device coupled to the display device; activate the plurality of IR LEDs according to an IR illumination pattern, where the IR illumination pattern may be defined spatially based on one of an arrangement of the IR LEDs and an arrangement of light extraction features; and deactivate the IR LEDs upon completion of the IR image capture.

According to yet other examples, the IR LEDs and the visible light LEDs may be spatially arranged in the light guide panel to generate the determined IR illumination pattern. The light extraction layer may include a plurality of light extraction features and a subset of the light extraction features with high efficiency for IR light extraction may be spatially arranged to generate the determined IR illumination pattern. The display device may further Include a plurality of driver circuits, where the driver circuits may be configured to activate the IR LEDs and the visible light LEDs based on instructions from the processor.

According to some examples, a means for providing background infrared (IR) illumination for IR image capture is described. The means may include a means for detecting activation of an IR image capture device associated with the computing device; a means for determining an IR illumination pattern; a means for activating a plurality of IR light emitting diodes (LEDs) interspersed with visible light LEDs of a display of the computing device according to the IR illumination pattern, where the activation of the IR LEDs is controlled spatially or temporally; and a means for deactivating the IR LEDs upon completion of the IR image capture.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide background infrared (IR) illumination for IR image capture, the computing device comprising:
a display configured to present visible content and IR illumination;
a memory configured to store instructions; and
a processor configured to execute a display control module, wherein the display control module is configured to:
detect activation of an IR image capture device associated with the computing device;
activate a plurality of IR light emitting diodes (LEDs) interspersed in between a plurality of visible light LEDs according to an IR illumination pattern, wherein the IR illumination pattern is defined
spatially based on one of an arrangement of the IR LEDs and an arrangement of light extraction features of the display, or
temporally through activation of the IR LEDs during an IR illumination frame, the IR illumination frame being preceded and succeeded by a plurality of visible Illumination frames; and
deactivate the IR LEDs upon completion of the IR image capture.

2. The computing device of claim 1, wherein a shape and a location of the IR illumination pattern on the display is selected based on one or more of a type of the IR image capture device, a type of the IR image capture, and an environmental lighting status.

3. The computing device of claim 1, wherein the IR illumination pattern is defined by spatial arrangement of a first subset of light extraction features that have high efficiency near IR wavelengths and a second subset of light extraction features that have high efficiency near visible light wavelengths.

4. The computing device of claim 1, wherein the display control module is further configured to display a combination of visible content and IR illumination during the IR illumination frame.

5. The computing device of claim 1, wherein the IR LEDs are activated through driver circuits distinct from driver circuits for the visible light LEDs.

6. The computing device of claim 1, wherein a number of the IR LEDs is smaller than a number of the visible light LEDs.

7. The computing device of claim 1, wherein a number of the IR LEDs is about equal to a number of the visible light LEDs.

8. The computing device of claim 1, wherein the IR illumination pattern is provided through a displayed text or shape over a uniform visible background pattern on the display.

9. The computing device of claim 1, wherein the display control module is one of a standalone module, part of an image capture application, and part of an operating system.

10. The computing device of claim 1, wherein the IR image capture device is integrated with the computing device.

11. The computing device of claim 1, wherein the visible light LEDs comprise one of white light LEDs, monochrome LEDs, and colored LEDs according to a color scheme of the display.

12. A method to provide background infrared (IR) illumination for IR image capture, the method comprising:
detecting activation of an IR image capture device associated with the computing device;
determining an IR illumination pattern;
activating a plurality of IR light emitting diodes (LEDs) interspersed with visible light LEDs of a display of the computing device according to the IR illumination pattern, wherein the activation of the IR LEDs is controlled spatially or temporally; and
deactivating the IR LEDs upon completion of the IR image capture.

13. The method of claim 12, wherein determining the IR illumination pattern comprises one of:
receiving an IR illumination pattern definition, and
selecting the IR illumination pattern from a plurality of IR illumination patterns.

14. The method of claim 13, further comprising:
selecting the IR illumination pattern from the plurality of IR illumination patterns based on one or more of a type of the IR image capture device, a type of the IR image capture, and an environmental lighting status.

15. The method of claim 14, wherein the type of the IR image capture includes one from a set of a facial recognition, a retinal recognition, and a scene capture.

16. The method of claim 12, wherein activating the plurality of IR LEDs comprises:
turning the IR LEDs on during an IR illumination frame, wherein the IR illumination frame is preceded and succeeded fey a plurality of visible illumination frames.

17. A display device to provide background infrared (IR) illumination for IR image capture, the display device comprising:
a display panel;
a light guide panel electrically and optically coupled to the display panel, wherein the light guide panel comprises a light extraction layer, a plurality of visible light emitting diodes (LEDs), and a plurality of IR LEDs interspersed in between the visible light LEDs; and
a processor configured to:
detect activation of an IR image capture device coupled to the display device;
activate the plurality of IR LEDs according to an IR illumination pattern, wherein the IR illumination pattern is defined spatially based on one of an arrangement of the IR LEDs and an arrangement of light extraction features; and
deactivate the IR LEDs upon completion of the IR image capture.

18. The display device of claim 17, wherein the IR LEDs and the visible light LEDs are spatially arranged in the light guide panel to generate the determined IR illumination pattern.

19. The display device of claim 17, wherein
the light extraction layer comprises a plurality of light extraction features, and
a subset of the plurality of light extraction features that have a high efficiency for IR light extraction are spatially arranged to generate the determined IR illumination pattern.

20. The display device of claim 17, further comprising a plurality of driver circuits, wherein the driver circuits are configured to activate the IR LEDs and the visible light LEDs based on instructions from the processor.
